(19) United States
(12) Patent Application Publication
(10) Pub. No.: US 2014/0122567 A1
(43) Pub. Date: May 1, 2014

(54) PREEMPTIVE FRAMEWORK FOR ACCESSING SHORT URLS

(71) Applicant: QUALCOMM INCORPORATED, San Diego, CA (US)

(72) Inventor: Vijay Suryavanshi, San Diego, CA (US)

(73) Assignee: QUALCOMM INCORPORATED, San Diego, CA (US)

(21) Appl. No.: 13/663,627

(22) Filed: Oct. 30, 2012

(51) Int. Cl. G06F 15/16

(52) U.S. Cl. 709/203

(57) ABSTRACT

The disclosure is directed to obtaining metadata related to a target of a short uniform resource locator (URL). An embodiment transmits the short URL to a server, receives a response from the server, wherein the response includes a pointer to an actual URL, requests metadata related to the actual URL from the server, and receives the metadata for the actual URL from the server. An embodiment confirms a target of a short URL. The embodiment receives the short URL, obtains metadata related to an actual URL based on the short URL, extracts a host website from the metadata, determines whether the actual URL points to the host website, and sends a notification of a result of the determination.

### BACKGROUND OF THE INVENTION

1. Field of the Invention

The disclosure is directed to providing a preemptive framework for accessing short URLs.

2. Description of the Related Art

Certain messaging systems, such as short message service (SMS), microblogging services, and the like, limit the number of characters that can be transmitted in a message. Short uniform resource locators (URLs) are a convenient way of representing URLs in such systems. Rather than send a full-length URL, a user can send a short URL, which is a substantially shorter version of the actual URL, but that still directs to the same location. There are a number of URL shortening services that allow users to create short URLs.

For example, the URL http://example.com/index.asp?mod=profiles&id=193 might be converted to http://examp.le/3plcydx. The actual URL is 48 characters long, while the short URL is 23 characters long.

A short URL obscures the actual URL. Thus, when a user receives a short URL, the user has no way of knowing the target of the short URL until the user clicks on it. As a result, short URLs can be used to redirect to unexpected sites, scam pages, or pages containing malware or cross-site scripting (XSS) attacks. Pages containing malware or XSS attacks often use short URLs to bypass URL blacklists. Because of this, some websites prevent short URLs from being posted.

### SUMMARY

The disclosure is directed to obtaining metadata related to a target of a short uniform resource locator (URL). An embodiment transmits the short URL to a server, receives a response from the server, wherein the response includes a pointer to an actual URL, requests metadata related to the actual URL from the server, and receives the metadata for the actual URL from the server. An embodiment confirms a target of a short URL. The embodiment receives the short URL, obtains metadata related to an actual URL based on the short URL, extracts a host website from the metadata, determines whether the actual URL points to the host website, and sends a notification of a result of the determination.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 illustrates a high-level system architecture of a wireless communications system in accordance with an embodiment of the invention.

FIG. 2 illustrates examples of user equipments (UEs) in accordance with embodiments of the invention.

FIG. 3 illustrates a communication device that includes logic configured to perform functionality in accordance with an embodiment of the invention.

FIG. 4 illustrates an exemplary short URL call flow.

FIG. 5 illustrates an exemplary short URL call flow according to an embodiment.

FIG. 6 illustrates exemplary screenshots of a UE according to an embodiment.

FIG. 7 illustrates an exemplary flow of an embodiment that can be performed by a UE or a server.

FIG. 8 illustrates an exemplary flow of an embodiment, in which the target of a short URL is confirmed.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A client device, referred to herein as a user equipment (UE), may be mobile or stationary, and may communicate with a radio access network (RAN). As used herein, the term “UE” may be referred to interchangeably as an “access terminal” or “AT,” a “wireless device,” a “subscriber device,” a “subscriber terminal,” a “subscriber station,” a “user terminal” or UT, a “mobile terminal,” a “mobile station” and variations thereof. Generally, UEs can communicate with a core network via the RAN, and through the core network the UEs can be connected with external networks such as the Internet. Of course, other mechanisms of connecting to the core network and/or the Internet are also possible for the UEs, such as over wired access networks, WiFi networks (e.g., based on IEEE 802.11, etc.) and so on. UEs can be embodied by any of a number of types of devices including but not limited to PC cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

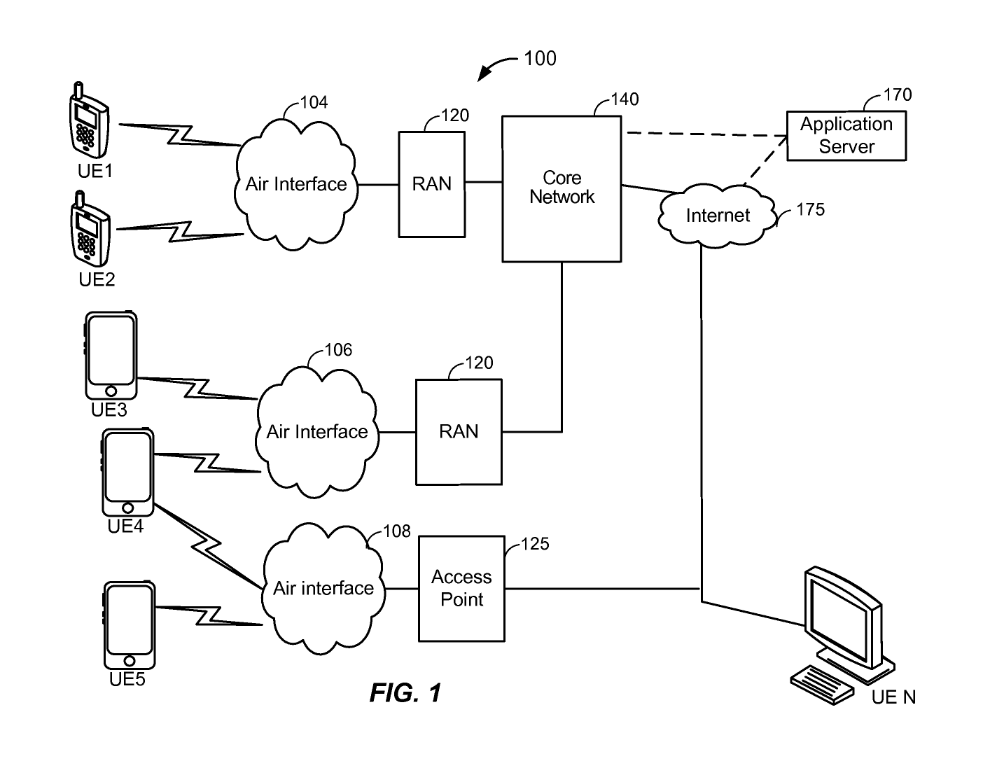

FIG. 1 illustrates a high-level system architecture of a wireless communications system 100 in accordance with an embodiment of the invention. The wireless communications system 100 contains UEs 1 . . . N. The UEs 1 . . . N can include cellular telephones, personal digital assistant (PDAs), pagers, a laptop computer, a desktop computer, and so on. For example, in FIG. 1, UEs 1 . . . 2 are illustrated as cellular calling phones, UEs 3 . . . 5 are illustrated as cellular touchscreen phones or smart phones, and UE N is illustrated as a desktop computer or PC.

Referring to FIG. 1, UEs 1 . . . N are configured to communicate with an access network (e.g., the RAN 120, an access point 125, etc.) over a physical communications interface or layer, shown in FIG. 1 as air interfaces 104, 106, 108 and/or a direct wired connection. The air interfaces 104 and 106 can comply with a given cellular communications protocol (e.g., CDMA, EVDO, eHRPD, GSM, EDGE, W-CDMA, LTE, etc.), while the air interface 108 can comply with a wireless IP protocol (e.g., IEEE 802.11). The RAN 120 includes a plurality of access points that serve UEs over air interfaces, such as the air interfaces 104 and 106. The access points in the RAN 120 can be referred to as access nodes or ANs, access points or APs, base stations or BSs, Node Bs, eNode Bs, and so on. These access points can be terrestrial access points (or ground stations), or satellite access points. The RAN 120 is configured to connect to a core network 140 that can perform a variety of functions, including bridging circuit switched (CS) calls between UEs served by the RAN 120 and other UEs served by the RAN 120 or a different RAN altogether, and can also mediate an exchange of packet-switched (PS) data with external networks such as Internet 175. The Internet 175 includes a number of routing agents and processing agents (not shown in FIG. 1 for the sake of convenience). In FIG. 1, UE N is shown as connecting to the Internet 175 directly (i.e., separate from the core network 140, such as over an Ethernet connection of WiFi or 802.11-based network). The Internet 175 can thereby function to bridge packet-switched data communications between UE N and UEs 1 . . . N via the core network 140. Also shown in FIG. 1 is the access point 125 that is separate from the RAN 120. The access point 125 may be connected to the Internet 175 independent of the core network 140 (e.g., via an optical communication system such as FiOS, a cable modem, etc.). The air interface 108 may serve UE 4 or UE 5 over a local wireless connection, such as IEEE 802.11 in an example. UE N is shown as a desktop computer with a wired connection to the Internet 175, such as a direct connection to a modem or router, which can correspond to the access point 125 itself in an example (e.g., for a WiFi router with both wired and wireless connectivity).

Referring to FIG. 1, an application server 170 is shown as connected to the Internet 175, the core network 140, or both. The application server 170 can be implemented as a plurality of structurally separate servers, or alternately may correspond to a single server. As will be described below in more detail, the application server 170 is configured to support one or more communication services (e.g., Voice-over-Internet Protocol (VoIP) sessions, Push-to-Talk (PTT) sessions, group communication sessions, social networking services, etc.) for UEs that can connect to the application server 170 via the core network 140 and/or the Internet 175.

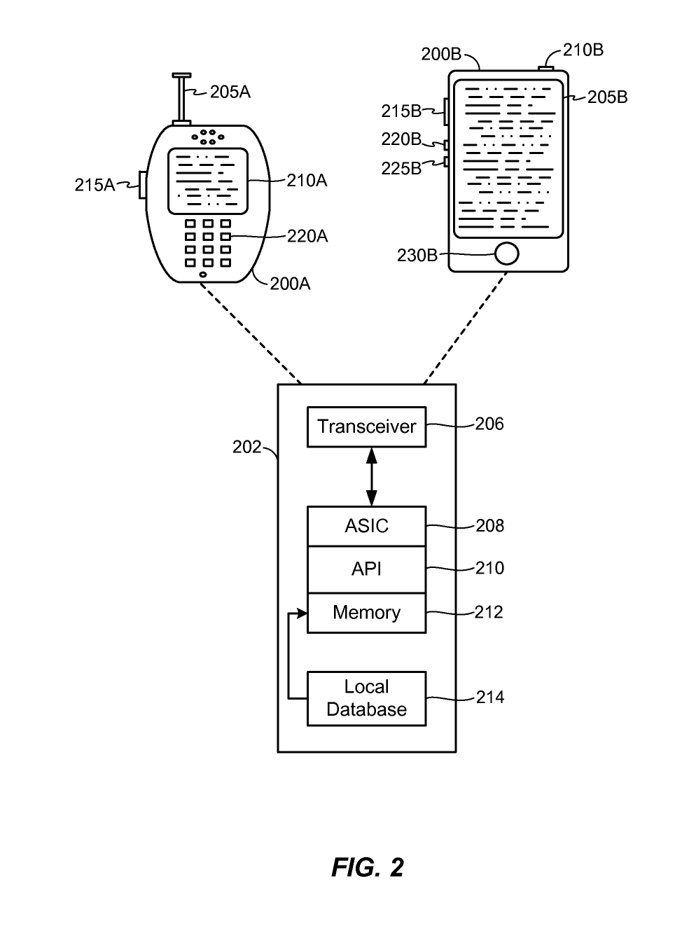

FIG. 2 illustrates examples of UEs in accordance with embodiments of the invention. Referring to FIG. 2, UE 200A is illustrated as a calling telephone and UE 200B is illustrated as a touchscreen device (e.g., a smart phone, a tablet computer, etc.). As shown in FIG. 2, an external casing of UE 200A is configured with an antenna 205A, display 210A, at least one button 215A (e.g., a PTT button, a power button, a volume control button, etc.) and a keypad 220A among other components, as is known in the art. Also, an external casing of UE 200B is configured with a touchscreen display 205B, peripheral buttons 210B, 215B, 220B and 225B (e.g., a power control button, a volume or vibrate control button, an airplane mode toggle button, etc.), at least one front-panel button 230B (e.g., a Home button, etc.), among other components, as is known in the art. While not shown explicitly as part of UE 200B, the UE 200B can include one or more external antennas and/or one or more integrated antennas that are built into the external casing of UE 200B, including but not limited to WiFi antennas, cellular antennas, satellite position system (SPS) antennas (e.g., global positioning system (GPS) antennas), and so on.

While internal components of UEs such as the UEs 200A and 200B can be embodied with different hardware configurations, a basic high-level UE configuration for internal hardware components is shown as platform 202 in FIG. 2. The platform 202 can receive and execute software applications, data and/or commands transmitted from the RAN 120 that may ultimately come from the core network 140, the Internet 175 and/or other remote servers and networks (e.g., application server 170, web URLs, etc.). The platform 202 can also independently execute locally stored applications without RAN interaction. The platform 202 can include a transceiver 206 operably coupled to an application specific integrated circuit (ASIC) 208, or other processor, microprocessor, logic circuit, or other data processing device. The ASIC 208 or other processor executes the application programming interface (API) 210 layer that interfaces with any resident programs in the memory 212 of the wireless device. The memory 212 can be comprised of read-only memory (ROM) or random-access memory (RAM), electrically erasable programmable ROM (EEPROM), flash cards, or any memory common to computer platforms. The platform 202 also can include a local database 214 that can store applications not actively used in memory 212, as well as other data. The local database 214 is typically a flash memory cell, but can be any secondary storage device as known in the art, such as magnetic media, EEPROM, optical media, tape, soft or hard disk, or the like.

Accordingly, an embodiment of the invention can include a UE (e.g., UE 200A, 200B, etc.) including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 208, memory 212, API 210 and local database 214 may all be used cooperatively to load, store and execute the various functions disclosed herein and thus the logic to perform these functions may be distributed over various elements. Alternatively, the functionality could be incorporated into one discrete component. Therefore, the features of the UEs 200A and 200B in FIG. 2 are to be considered merely illustrative and the invention is not limited to the illustrated features or arrangement.

The wireless communication between the UEs 200A and/or 200B and the RAN 120 can be based on different technologies, such as CDMA, W-CDMA, time division multiple access (TDMA), frequency division multiple access (FDMA), Orthogonal Frequency Division Multiplexing (OFDM), GSM, or other protocols that may be used in a wireless communications network or a data communications network. As discussed in the foregoing and known in the art, voice transmission and/or data can be transmitted to the UEs from the RAN using a variety of networks and configurations. Accordingly, the illustrations provided herein are not intended to limit the embodiments of the invention and are merely to aid in the description of aspects of embodiments of the invention.

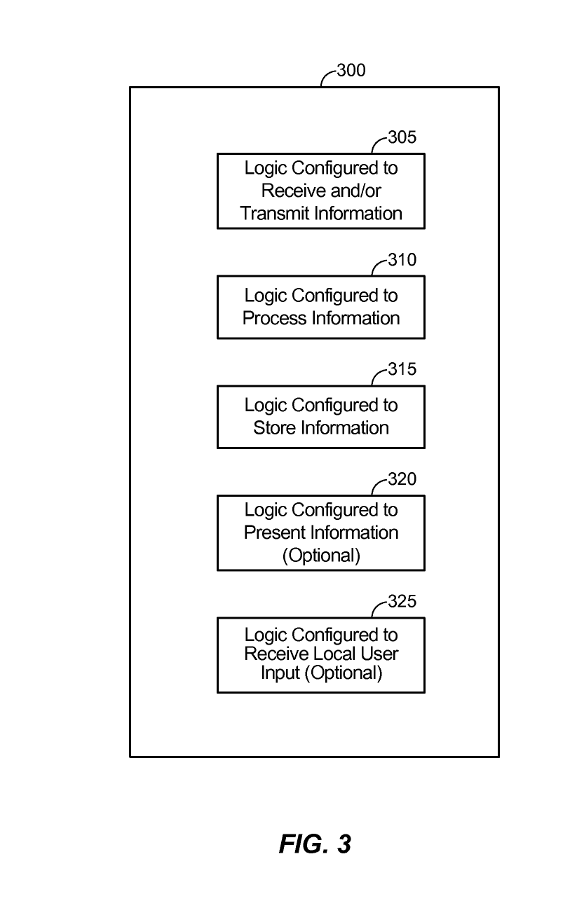

FIG. 3 illustrates a communication device 300 that includes logic configured to perform functionality. The communication device 300 can correspond to any of the above-noted communication devices, including but not limited to UEs 200A or 200B, any component of the RAN 120, any component of the core network 140, any components coupled with the core network 140 and/or the Internet 175 (e.g., the application server 170), and so on. Thus, communication device 300 can correspond to any electronic device that is configured to communicate with (or facilitate communication with) one or more other entities over the wireless communications system 100 of FIG. 1.

Referring to FIG. 3, the communication device 300 includes logic configured to receive and/or transmit information 305. In an example, if the communication device 300 corresponds to a wireless communications device (e.g., UE 200A or 200B), the logic configured to receive and/or transmit information 305 can include a wireless communications interface (e.g., Bluetooth, WiFi, 2G, CDMA, W-CDMA, 3G, 4G, LTE, etc.) such as a wireless transceiver and associated hardware (e.g., an RF antenna, a MODEM, a modulator and/or demodulator, etc.). In another example, the logic configured to receive and/or transmit information 305 can correspond to a wired communications interface (e.g., a serial connection, a USB or Firewire connection, an Ethernet connection through which the Internet 175 can be accessed, etc.). Thus, if the communication device 300 corresponds to some type of network-based server (e.g., the application 170), the logic configured to receive and/or transmit information 305 can correspond to an Ethernet card, in an example, that connects the network-based server to other communication entities via an Ethernet protocol. In a further example, the logic configured to receive and/or transmit information 305 can include sensory or measurement hardware by which the communication device 300 can monitor its local environment (e.g., an accelerometer, a temperature sensor, a light sensor, an antenna for monitoring local RF signals, etc.). The logic configured to receive and/or transmit information 305 can also include software that, when executed, permits the associated hardware of the logic configured to receive and/or transmit information 305 to perform its reception and/or transmission function(s). However, the logic configured to receive and/or transmit information 305 does not correspond to software alone, and the logic configured to receive and/or transmit information 305 relies at least in part upon hardware to achieve its functionality.

Referring to FIG. 3, the communication device 300 further includes logic configured to process information 310. In an example, the logic configured to process information 310 can include at least a processor. Example implementations of the type of processing that can be performed by the logic configured to process information 310 includes but is not limited to performing determinations, establishing connections, making selections between different information options, performing evaluations related to data, interacting with sensors coupled to the communication device 300 to perform measurement operations, converting information from one format to another (e.g., between different protocols such as .wmv to .avi, etc.), and so on. For example, the processor included in the logic configured to process information 310 can correspond to a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 310 can also include software that, when executed, permits the associated hardware of the logic configured to process information 310 to perform its processing function(s). However, the logic configured to process information 310 does not correspond to software alone, and the logic configured to process information 310 relies at least in part upon hardware to achieve its functionality.

Referring to FIG. 3, the communication device 300 further includes logic configured to store information 315. In an example, the logic configured to store information 315 can include at least a non-transitory memory and associated hardware (e.g., a memory controller, etc.). For example, the non-transitory memory included in the logic configured to store information 315 can correspond to RAM memory, flash memory, ROM memory, EPROM memory, EEPROM memory, registers, hard disk, a removable disk, a CD-ROM, or any other form of storage medium known in the art. The logic configured to store information 315 can also include software that, when executed, permits the associated hardware of the logic configured to store information 315 to perform its storage function(s). However, the logic configured to store information 315 does not correspond to software alone, and the logic configured to store information 315 relies at least in part upon hardware to achieve its functionality.

Referring to FIG. 3, the communication device 300 further optionally includes logic configured to present information 320. In an example, the logic configured to present information 320 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 300. For example, if the communication device 300 corresponds to UE 200A or UE 200B as shown in FIG. 2, the logic configured to present information 320 can include the display 210A of UE 200A or the touchscreen display 205B of UE 200B. In a further example, the logic configured to present information 320 can be omitted for certain communication devices, such as network communication devices that do not have a local user (e.g., network switches or routers, remote servers, etc.). The logic configured to present information 320 can also include software that, when executed, permits the associated hardware of the logic configured to present information 320 to perform its presentation function(s). However, the logic configured to present information 320 does not correspond to software alone, and the logic configured to present information 320 relies at least in part upon hardware to achieve its functionality.

Referring to FIG. 3, the communication device 300 further optionally includes logic configured to receive local user input 325. In an example, the logic configured to receive local user input 325 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 300. For example, if the communication device 300 corresponds to UE 200A or UE 200B as shown in FIG. 2, the logic configured to receive local user input 325 can include the keypad 220A, any of the buttons 215A or 210B through 225B, the touchscreen display 205B, etc. In a further example, the logic configured to receive local user input 325 can be omitted for certain communication devices, such as network communication devices that do not have a local user (e.g., network switches or routers, remote servers, etc.). The logic configured to receive local user input 325 can also include software that, when executed, permits the associated hardware of the logic configured to receive local user input 325 to perform its input reception function(s). However, the logic configured to receive local user input 325 does not correspond to software alone, and the logic configured to receive local user input 325 relies at least in part upon hardware to achieve its functionality.

Referring to FIG. 3, while the configured logics of 305 through 325 are shown as separate or distinct blocks in FIG. 3, it will be appreciated that the hardware and/or software by which the respective configured logic performs its functionality can overlap in part. For example, any software used to facilitate the functionality of the configured logics of 305 through 325 can be stored in the non-transitory memory associated with the logic configured to store information 315, such that the configured logics of 305 through 325 each performs their functionality (i.e., in this case, software execution) based in part upon the operation of software stored by the logic configured to store information 315. Likewise, hardware that is directly associated with one of the configured logics can be borrowed or used by other configured logics from time to time. For example, the processor of the logic configured to process information 310 can format data into an appropriate format before being transmitted by the logic configured to receive and/or transmit information 305, such that the logic configured to receive and/or transmit information 305 performs its functionality (i.e., in this case, transmission of data) based in part upon the operation of hardware (i.e., the processor) associated with the logic configured to process information 310.

Generally, unless stated otherwise explicitly, the phrase “logic configured to” as used throughout this disclosure is intended to invoke an embodiment that is at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the embodiments described below in more detail.

Certain messaging systems, such as short message service (SMS), microblogging services, and the like, limit the number of characters that can be transmitted in a message. Short uniform resource locators (URLs) are a convenient way of representing URLs in such systems. Rather than send a full-length URL, a user can send a short URL, which is a substantially shorter version of the actual URL, but that still directs to the same location. There are a number of URL shortening services that allow users to create short URLs.

For example, the URL http://example.com/index.asp?mod=profiles&id=193 might be converted to http://examp.le/3plcydx. The actual URL is 48 characters long, while the short URL is 23 characters long.

The content located at a URL is typically obtained using hypertext transport protocol (HTTP). HTTP is a request-response protocol for the client-server computing model. When a client wishes to obtain content, such as a webpage, located at a particular URL, the client sends an HTTP GET request to the server identified by the URL. The server responds with an HTTP response header and the content. The response header includes header fields that give information about the server and about further access to the content identified by the URL, such as Location, Host, Content-Type, Content-Length, Server, and the like.

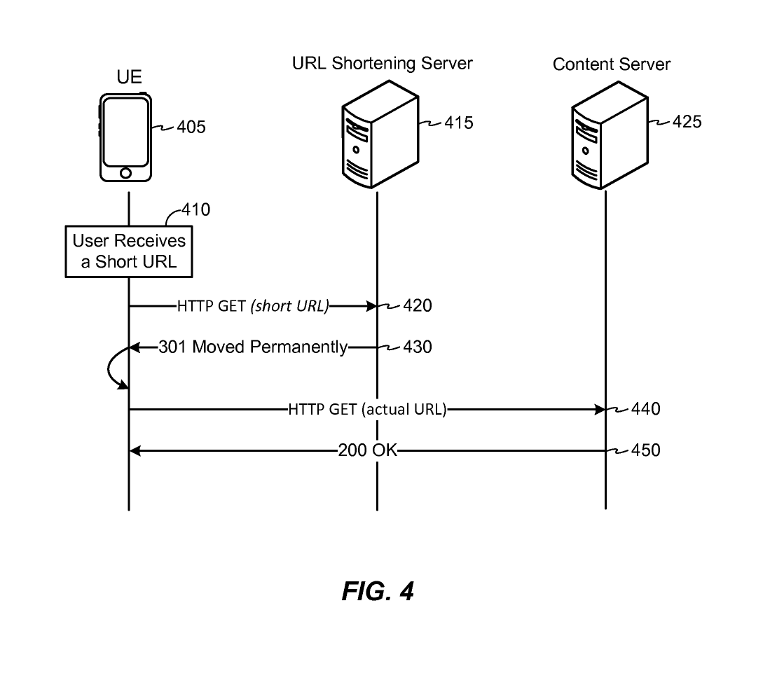

FIG. 4 illustrates an exemplary short URL call flow. At 410, a UE 405 receives a short URL. The short URL may be received in, for example, a micropost from a microblogging service. At 420, the UE 405 sends an HTTP GET message to the URL shortening server 415 requesting the content located at the short URL. The URL shortening server 415 is the server that created the short URL from the actual URL, and is identified by the short URL. At 430, the URL shortening server 415 replies with an HTTP 301 “Moved Permanently” response, which includes a pointer to the actual URL in the Location field of the response header. The pointer is typically a redirect URL that includes the actual URL. At 440, the UE 405 sends an HTTP GET message to the content server 425 identified in the actual URL requesting the content located at the actual URL. At 450, the content server 425 replies with an HTTP 200 “OK” response. The response includes a content header and the content located at the actual URL.

A short URL obscures the actual URL. Thus, when a user receives a short URL, the user has no way of knowing the target of the short URL until the user clicks on it. As a result, short URLs can be used to redirect to unexpected sites, scam pages, or pages containing malware or cross-site scripting (XSS) attacks. Pages containing malware or XSS attacks often use short URLs to bypass URL blacklists. Because of this, some websites prevent short URLs from being posted.

There are current solutions that address some of the issues with short URLs. One service allows a user to enter a short URL into a search field and recovers the actual URL. Another service generates short URLs that have a “preview” field in the URL string itself. These short URLs allow users to see the actual URL before they click on the short URL. Yet another service allows users to add a question mark to the end of a short URL to see the actual URL. Another type of service performs various safety checks to verify the actual URL before generating a short URL.

The various embodiments preemptively fetch metadata associated with the short URL without actually downloading the content associated with the actual URL. The metadata can include content associated with the actual URL, such as the content type, the size of the content, the host name associated with the content, and/or the actual URL behind the short URL. Other local details can be integrated as well, such as a user defined blacklist for certain websites. Presenting the user with this metadata provides the user with a sneak peek of the actual URL before deciding whether or not to follow the short URL.

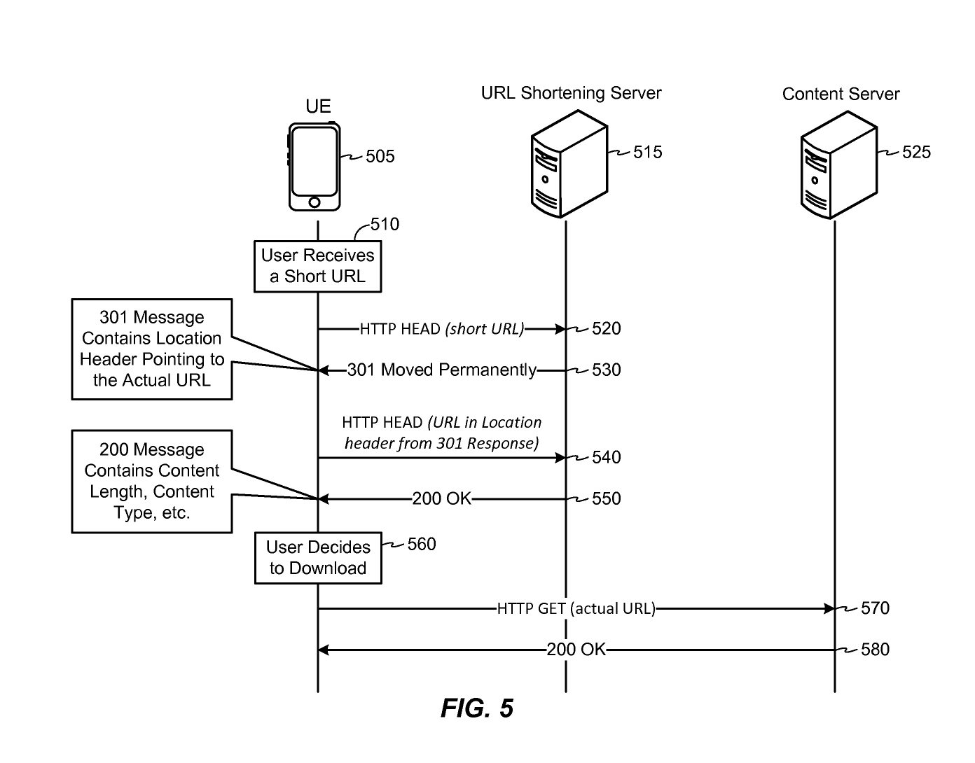

FIG. 5 illustrates an exemplary short URL call flow according to an embodiment. At 510, a UE 505 receives a short URL. The short URL may be received in, for example, a micropost from a microblogging service. At 520, the UE 505 sends an HTTP HEAD message to the URL shortening server 515. A HEAD message asks for a response identical to the one that would be received for a GET request, but without the content. That is, the response to a HEAD message is just the HTTP response header. Accordingly, at 530, the URL shortening server 515 responds with an HTTP 301 “Moved Permanently” message that has a pointer to the actual URL in the Location header field.

At 540, the UE 505 sends another HTTP HEAD message to the URL shortening server, this time containing the pointer URL that was in the Location header field of the 301 response. The pointer URL contains the actual URL. At 550, the URL shortening server 515 responds with a 200 “OK” message, which contains the response header for the actual URL.

The UE 505 can extract metadata about the actual URL and the associated content from the response header and display it to the user so that the user can decide whether or not to download the content. The metadata can include the actual URL extracted from the Location field, the host name extracted from the Server field, the multipurpose internet mail extensions (MIME) type of the content extracted from the Content-Type field, the size of the content extracted from the Content-Length field, and the like.

At 560, after viewing the returned metadata, the user decides to download the content at the actual URL. Accordingly, at 570, the UE 505 sends an HTTP GET message to the content server 525 identified in the actual URL requesting the content located at the actual URL. At 580, the content server 525 replies with an HTTP 200 “OK” response. The response includes a response header and the content located at the actual URL.

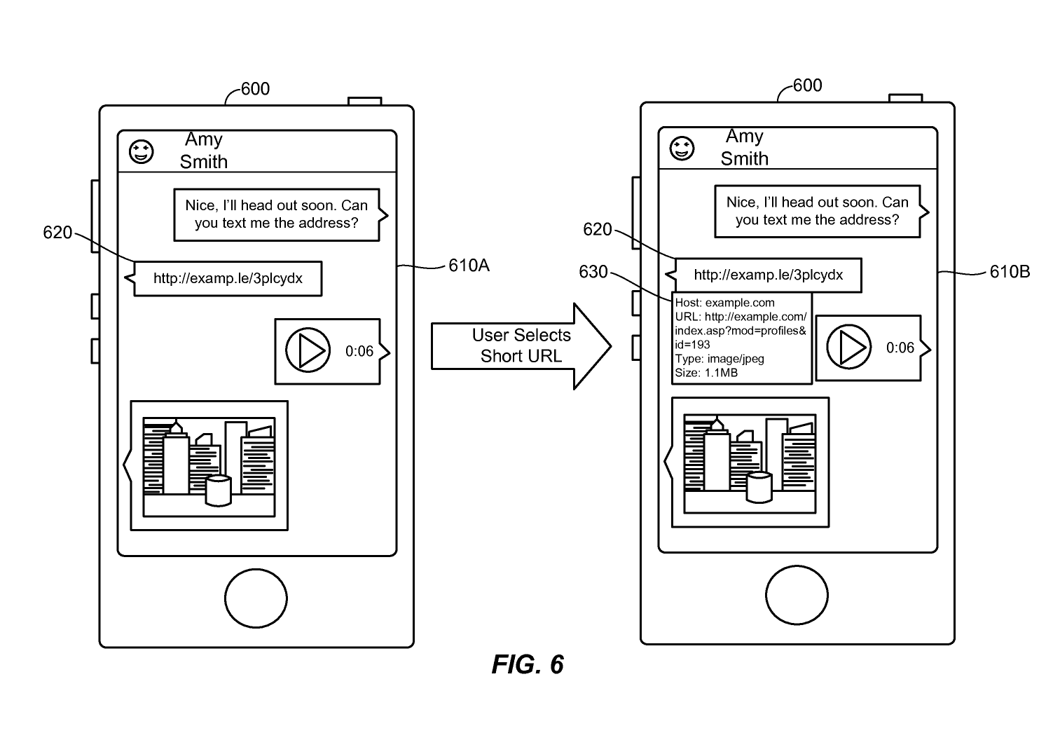

FIG. 6 illustrates exemplary screenshots 610A and 610B of a UE 600 according to an embodiment. In the example of FIG. 6, the user is engaged in a text messaging conversation with someone named Amy Smith. During the conversation, Amy Smith texts the user a short URL in an SMS message 620. As shown in screenshot 610A, the SMS message 620 is initially displayed as any other SMS message would be. However, as shown in screenshot 610B, when the user selects the short URL, or the SMS message 620 containing it, such as by touching it, an information box 630 appears showing the details of the actual URL. The user can then decide whether or not to follow the short URL by touching it again.

While FIG. 6 illustrates an embodiment in which a short URL is received in an SMS message, it is apparent that the various embodiments are not so limited. The various embodiments apply to short URLs regardless of how received. For example, the short URLs can be received in microblogging service messages (e.g. microposts), mobile email service messages, etc. Also, a webpage optimized for a mobile web browser may display short URLs rather than full-length URLs. Even web pages and email services optimized for desktop environments may use short URLs for various reasons.

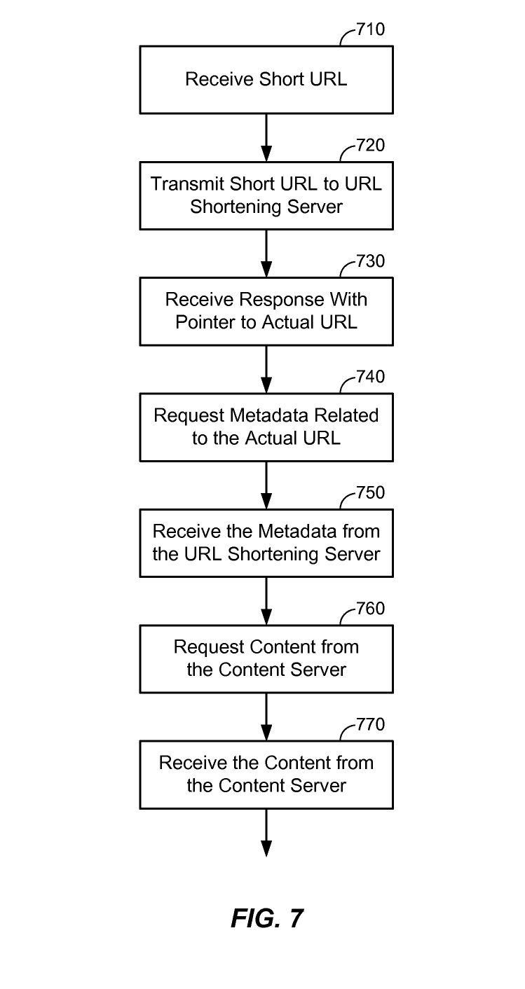

FIG. 7 illustrates an exemplary flow of an embodiment that can be performed by a UE or a server. At 710, the UE or server receives a short URL. The UE may receive the short URL in a text message, a micropost, an email, a webpage, etc. The server may receive the short URL from a UE. At 720, the UE or server transmits the short URL to the URL shortening server that generated the short URL. At 730, the UE or server receives a response containing a pointer to the actual URL. At 740, the UE or server sends a request for metadata related to the actual URL to the URL shortening server. At 750, the UE or server receives the metadata from the URL shortening server. At 760, the UE or server sends a request to the content server identified in the actual URL requesting the content located at the actual URL. At 770, the UE or server receives the content from the content server.

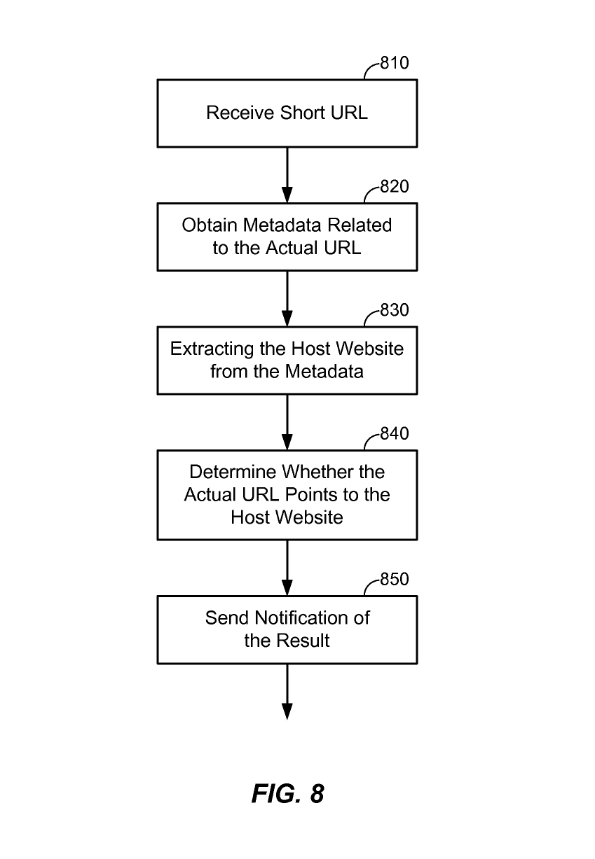

FIG. 8 illustrates an exemplary flow of an embodiment, in which the target of a short URL is confirmed. The embodiment of FIG. 8 can be performed at a server or a UE. The server may be a URL shortening server or some other proxy server. At 810, the server or UE receives a short URL. The UE may receive the short URL in a text message, a micropost, an email, a webpage, etc. The server may receive the short URL from a UE.

At 820, the server or UE obtains metadata related to the actual URL based on the short URL. This can be accomplished according to the embodiment of FIG. 7. At 830, the server or UE extracts a host website from the obtained metadata. The host website can be extracted from a field in the HTTP response header containing the host website or from the pointer URL in the Location field.

The actual URL may not actually direct to this host website. Accordingly, at 840, the server or UE determines whether the actual URL actually points to the host website. At 850, the server or UE then sends a notification of the result of this determination. If the actual URL points to the host website, the notification may be a confirmation, and if it does not, the notification may be an error message. If a UE is performing the embodiment of FIG. 8, the mobile device sends the notification to the user by displaying it on the user interface of the UE. If a server is performing the embodiment of FIG. 8, the server sends the notification to the UE from which it received the short URL.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method for obtaining metadata related to a target of a short uniform resource locator (URL), comprising:
transmitting the short URL to a server;
receiving a response from the server, wherein the response includes a pointer to an actual URL;
requesting metadata related to the actual URL from the server; and
receiving the metadata for the actual URL from the server.

2. The method of claim 1, wherein the transmitting the short URL comprises transmitting a hypertext transport protocol (HTTP) message containing the short URL.

3. The method of claim 2, wherein the HTTP message is an HTTP HEAD message.

4. The method of claim 1, wherein the server is a URL shortening server.

5. The method of claim 1, wherein the short URL is a shortened version of the actual URL.

6. The method of claim 1, wherein the response is an HTTP response header.

7. The method of claim 6, wherein the HTTP response header is part of an HTTP 301 message.

8. The method of claim 1, wherein the requesting the metadata comprises transmitting an HTTP message containing the pointer to the actual URL.

9. The method of claim 8, wherein the HTTP message is an HTTP HEAD message.

10. The method of claim 1, wherein the receiving the metadata comprises receiving an HTTP message containing the metadata.

11. The method of claim 10, wherein the HTTP message is an HTTP 200 message.

12. The method of claim 1, wherein the metadata includes at least one of:
the actual URL;
a type of content located at the actual URL;
a size of the content located at the actual URL; or
a host of the content located at the actual URL.

13. The method of claim 1, further comprising:
requesting content located at the actual URL from a content server hosting the content; and
receiving the content from the content server.

14. A method for confirming a target of a short uniform resource locator (URL), comprising:
receiving the short URL;
obtaining metadata related to an actual URL based on the short URL;
extracting a host website from the metadata;
determining whether the actual URL points to the host website; and
sending a notification of a result of the determining.

15. The method of claim 14, wherein the short URL is received from a mobile device, and wherein the sending comprises sending the notification to the mobile device.

16. The method of claim 14, wherein the receiving comprises receiving the short URL at a mobile device, and wherein the sending comprises displaying the notification on a user interface of the mobile device.

17. The method of claim 14, wherein the obtaining comprises:
transmitting the short URL to a server;
receiving a response from the server, wherein the response includes a pointer to the actual URL;
requesting the metadata related to the actual URL from the server; and
receiving the metadata for the actual URL from the server.

18. The method of claim 14, wherein the metadata is extracted from a hypertext transport protocol (HTTP) response header.

19. The method of claim 14, wherein the short URL is a shortened version of the actual URL.

20. An apparatus for obtaining metadata related to a target of a short uniform resource locator (URL), comprising:
logic configured to transmit the short URL to a server;
logic configured to receive a response from the server, wherein the response includes a pointer to an actual URL;
logic configured to request metadata related to the actual URL from the server; and
logic configured to receive the metadata for the actual URL from the server.

21. The apparatus of claim 20, wherein the logic configured to transmit the short URL comprises logic configured to transmit a hypertext transport protocol (HTTP) message containing the short URL.

22. The apparatus of claim 21, wherein the HTTP message is an HTTP HEAD message.

23. The apparatus of claim 20, wherein the server is a URL shortening server.

24. The apparatus of claim 20, wherein the short URL is a shortened version of the actual URL.

25. The apparatus of claim 20, wherein the response is an HTTP response header.

26. The apparatus of claim 25, wherein the HTTP response header is part of an HTTP 301 message.

27. The apparatus of claim 20, wherein the logic configured to request the metadata comprises logic configured to transmit an HTTP message containing the pointer to the actual URL.

28. The apparatus of claim 27, wherein the HTTP message is an HTTP HEAD message.

29. The apparatus of claim 20, wherein the logic configured to receive the metadata comprises logic configured to receive an HTTP message containing the metadata.

30. The apparatus of claim 29, wherein the HTTP message is an HTTP 200 message.

31. The apparatus of claim 20, wherein the metadata includes at least one of:
the actual URL;
a type of content located at the actual URL;
a size of the content located at the actual URL; or
a host of the content located at the actual URL.

32. The apparatus of claim 20, further comprising:
logic configured to request content located at the actual URL from a content server hosting the content; and
logic configured to receive the content from the content server.

33. An apparatus for confirming a target of a short uniform resource locator (URL), comprising:
logic configured to receive the short URL;
logic configured to obtain metadata related to an actual URL based on the short URL;
logic configured to extract a host website from the metadata;
logic configured to determine whether the actual URL points to the host website; and
logic configured to send a notification of a result of the determining.

34. The apparatus of claim 33, wherein the short URL is received from a mobile device, and wherein the logic configured to send comprises logic configured to send the notification to the mobile device.

35. The apparatus of claim 33, wherein the logic configured to receive comprises logic configured to receive the short URL at a mobile device, and wherein the logic configured to send comprises logic configured to display the notification on a user interface of the mobile device.

36. The apparatus of claim 33, wherein the logic configured to obtain comprises:
logic configured to transmit the short URL to a server;
logic configured to receive a response from the server, wherein the response includes a pointer to the actual URL;
logic configured to request metadata related to the actual URL from the server; and
logic configured to receive the metadata for the actual URL from the server.

37. The apparatus of claim 33, wherein the metadata is extracted from a hypertext transport protocol (HTTP) response header.

38. The apparatus of claim 33, wherein the short URL is a shortened version of the actual URL.

39. An apparatus for obtaining metadata related to a target of a short uniform resource locator (URL), comprising:
means for transmitting the short URL to a server;
means for receiving a response from the server, wherein the response includes a pointer to an actual URL;
means for requesting metadata related to the actual URL from the server; and
means for receiving the metadata for the actual URL from the server.

40. An apparatus for confirming a target of a short uniform resource locator (URL), comprising:
means for receiving the short URL;
means for obtaining metadata related to an actual URL based on the short URL;
means for extracting a host website from the metadata;
means for determining whether the actual URL points to the host website; and
means for sending a notification of a result of the determining.

41. A non-transitory computer-readable medium for obtaining metadata related to a target of a short uniform resource locator (URL), comprising:
at least one instruction to transmit the short URL to a server;
at least one instruction to receive a response from the server, wherein the response includes a pointer to an actual URL;
at least one instruction to request metadata related to the actual URL from the server; and
at least one instruction to receive the metadata for the actual URL from the server.

42. A non-transitory computer-readable medium for confirming a target of a short uniform resource locator (URL), comprising:
at least one instruction to receive the short URL;
at least one instruction to obtain metadata related to an actual URL based on the short URL;
at least one instruction to extract a host website from the metadata;
at least one instruction to determine whether the actual URL points to the host website; and
at least one instruction to send a notification of a result of the determining.
